(19) United States
(12) Patent Application Publication
(10) Pub. No.: US 2014/0359062 A1
(43) Pub. Date: Dec. 4, 2014

(54) DATA TRANSFERRING APPARATUS, DATA TRANSFERRING SYSTEM AND NON-TRANSITORY COMPUTER READABLE MEDIUM

(71) Applicant: KABUSHIKI KAISHA TOSHIBA, Tokyo (JP)

(72) Inventors: Masataka GOTO, Yokohama-Shi (JP); Kensaku YAMAGUCHI, Kawasaki-Shi (JP); Eimi MURAKAMI, Yokohama-Shi (JP); Takahiro YAMAURA, Kawasaki-Shi (JP)

(73) Assignee: KABUSHIKI KAISHA TOSHIBA, Tokyo (JP)

(21) Appl. No.: 14/195,961

(22) Filed: Mar. 4, 2014

(30) Foreign Application Priority Data
May 31, 2013 (JP) 2013-116072

(51) Int. Cl. H04L 29/08

(52) U.S. Cl. CPC H04L 67/10
USPC 709/217

(57) ABSTRACT

According to one embodiment, there is provided a data transferring apparatus to communicate with a communicating apparatus through a network in accordance with a predetermined protocol, including: a writing controller and a transmission controller. The writing controller performs control of writing a first response message containing first data to a storage. The transmission controller performs control of reading the first response message from the storage and transmitting the first response message to the communicating apparatus, upon receiving a data acquisition request message for the first data from the first communicating apparatus.

### CROSS-REFERENCE TO RELATED APPLICATIONS

This application is based upon and claims the benefit of priority from Japanese Patent Application No. 2013-116072, filed May 31, 2013; the entire contents of which are incorporated herein by reference.

### FIELD

Embodiments described herein relate to a data transferring apparatus, a data transferring system and a program.

### BACKGROUND

Conventionally, there is a server that stores data as a file in a storage, and that reads data from the storage to transmit them or writes data to the storage in response to a request from a client. In this case, data to be frequently accessed are placed in a DRAM (Dynamic Random Access Memory), and thereby, a fast response can be achieved. However, there is a problem in that an achievement of a fast response in a large storage capacity requires a large capacity of DRAM.

### BRIEF DESCRIPTION OF THE DRAWINGS

FIG. 1 shows an overall configuration of a data transferring system according to an embodiment of the present invention;

FIG. 2 shows a configuration of a caching server;

FIG. 3 shows an example of a data-holding structure;

FIG. 4 shows a data-holding management table (a hash table);

FIG. 5 shows an unused structure management table of data-holding structures;

FIG. 6 shows a process sequence when receiving a “GET” request;

FIG. 7 shows a configuration of the “GET” request message;

FIG. 8 shows a manner in which response data are stored;

FIG. 9 shows an example of a format of the response data;

FIG. 10 shows a process sequence when receiving a “SET” request message;

FIG. 11 shows an example in which an unused data-holding structure is specified;

FIG. 12 shows an example in which a data-holding structure is taken from the unused structure management table and is added to the data-holding management table;

FIG. 13 shows a sequence when a subsequent “GET” request arrives before flushing of response data;

FIG. 14 shows another example of a cache protocol message; and

FIG. 15 shows an example of an extended structure of a data-holding structure.

### DETAILED DESCRIPTION

According to one embodiment, there is provided a data transferring apparatus to communicate with a communicating apparatus through a network in accordance with a predetermined protocol, including: a writing controller and a transmission controller.

The writing controller performs control of writing a first response message containing first data to a storage.

The transmission controller performs control of reading the first response message from the storage and transmitting the first response message to the communicating apparatus, upon receiving a data acquisition request message for the first data from the communicating apparatus.

Hereinafter, an embodiment of the present invention will be described with reference to the drawings.

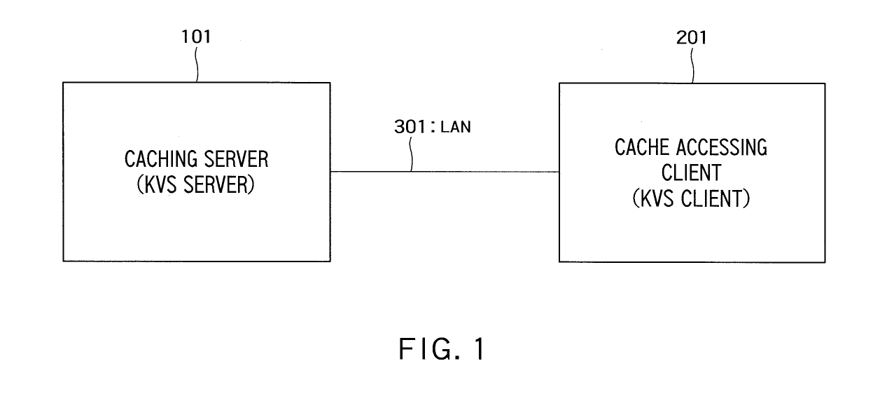

FIG. 1 shows an overall configuration of a data transferring system that has a caching server including a data transferring apparatus according to the embodiment, and a cache accessing client (hereinafter, a client).

A caching server 101 and a client 201 are connected through a network 301. Although only a single client is shown, multiple clients may be connected with the network 301.

In the embodiment, as the network 301, a LAN such as Ethernet (R), for example, is assumed, but any scheme is allowable. The network 301 is not limited to a LAN, and may be a wide area network or the Internet. In addition, the network may be a wired network or may be a wireless network.

The client 201 is a communication client apparatus that transmits and receives messages with the caching server 101 in a procedure (cache protocol) determined by the caching server 101. The caching server 101 includes a storage for storing data. One characteristic of the embodiment is that the storage stores data in a format of a response message in the cache protocol.

When receiving a data saving request message containing data as an object to be saved, from the client 201, the caching server 101 makes a response message (response data) containing the data and saves the response data in the storage. When receiving a data acquisition request message from the client 201, the caching server 101 reads the response data containing the acquisition-requested data from the storage.

The caching server 101 adds headers to the read response data so as to configure packets, and transmits the packets to the client 201. When receiving the acquisition request, it is not necessary to make a response message, and it is only necessary to read the response message (response data) made in advance, from the storage, and to add headers thereto and transmit them. Therefore, even if a capacity of the storage is made larger, a fast response is possible. Here, the client to perform a saving request of the data and the client to perform an acquisition request of the data may be the same or different.

In the embodiment, the caching server 101 adopts a storing method in which keys and values correspond to one another. Thereby, in some cases, the caching server 101 is called a key-value storing (KVS) server, and the client 201 may be called a KVS client.

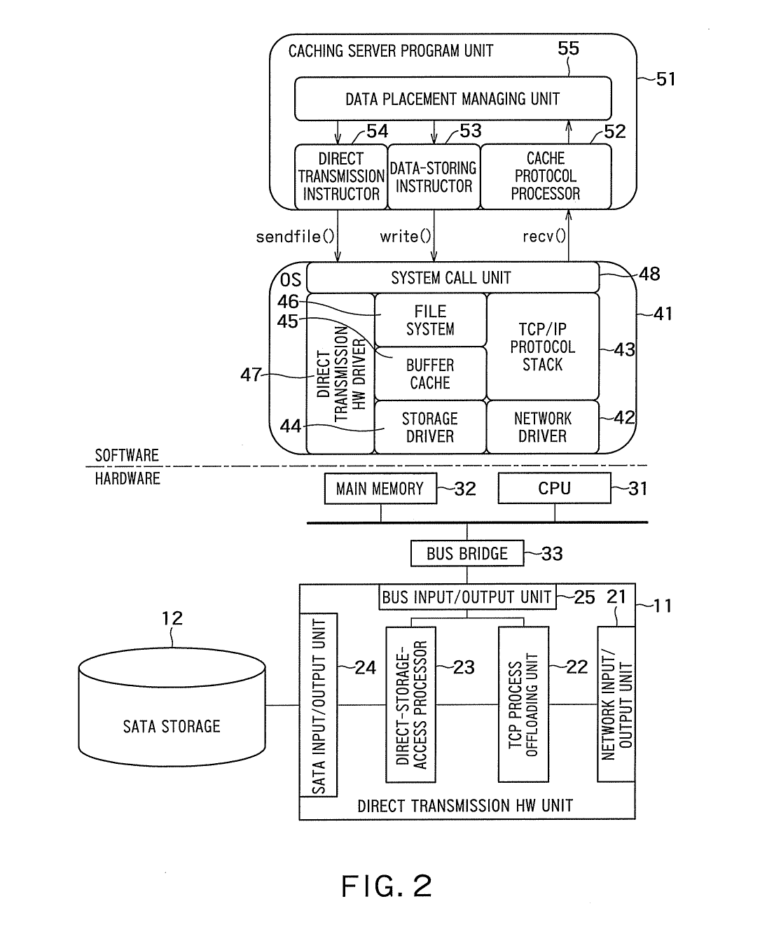

The lower side of FIG. 2 shows a hardware block diagram of the data transferring apparatus of the caching server 101. The upper side of FIG. 2 shows a functional block configuration of software to be executed by a CPU of the caching server 101.

As shown in the lower side of FIG. 2, the caching server 101 includes the data transferring apparatus and a SATA (Serial

Advanced Technology Attachment) storage 12. The data transferring apparatus includes a direct transmission HW (HardWare) unit (transmission apparatus) 11, a CPU 31, a main memory 32, and a bus bridge 33. The CPU 31 and the main memory 32 are a general CPU and main memory. As for the bus bridge 33, any scheme is allowable, as long as it is a bus to connect with a wide variety of devices, such as PCI Express.

The functional block diagram in the upper side of FIG. 2 is a functional block diagram to be implemented in an OS (operating system) 41 and an application 51 to operate on the OS 41, which are executed by the CPU 31. The software, which is stored in a storage not shown in the figure, is read to the main memory 32 to be executed, and thereby the functions of the blocks shown in the figure are implemented. In the case where a nonvolatile memory is used as the main memory 32, it is possible to adopt a scheme in which the software is stored in the main memory 32.

The direct transmission HW unit 11 includes a network input/output unit 21, a TCP process offloading unit 22, a direct-storage-access processor 23, a SATA input/output unit 24, and a bus input/output unit 25.

The network input/output unit 21 is a communication interface to connect with the network 301, and performs processes on the MAC layer.

The TCP process offloading unit 22 is a processing device to execute some of the TCP/IP communication protocol processes in hardware (HW). At the time of transmitting data, a TCP header and an IP header are added to the transmitting data. At the time of receiving data, whether the data has a connection associated therewith is checked based on a destination IP address of the IP header and a destination port of the TCP header. In the case of having such connection, the received data is passed to a TCP/IP protocol stack 43 of the OS 41. In the embodiment, the TCP process offloading unit 22 is configured by hardware, but it is allowable that the CPU executes software (mounted on the OS, for example) and thereby the function of the TCP process offloading unit is implemented. The SATA input/output unit 24 is an interface unit for connecting with the SATA storage 12. Here, the storage 12 is externally connected with the data transferring apparatus, but it may be configured to be connected through a network such as a LAN. In this case, the network may be the network 301 connected with the client 201, or may be a network different from this.

The direct-storage-access processor 23 accesses the SATA storage 12 in accordance with an instruction from a storage driver (writing controller) 44 of the OS 41. Furthermore, the unit 23 reads data (here, response data) from the SATA storage 12, and passes the data to the TCP process offloading unit 22, in accordance with an instruction of a direct transmission HW driver (transmission controller) 47 of the OS 41. The TCP process offloading unit 22 having received the data adds a TCP header and an IP header, and transmits the data to which these headers have been added, to the network 301 through the network input/output unit 21.

The bus input/output unit 25 is a device-side interface unit for connecting with the CPU 31 and the main memory 32, through a bus such as PCI Express, for example. The bus input/output unit 25 exchanges data between the CPU 31 and the main memory 32. Also, exchanging of process instructions by the CPU is performed between the CPU 31 and the main memory 32. Thereby, the instructions and data from the software (OS) can be exchanged with the direct transmission HW unit 11.

The OS 41 includes a network driver 42, the TCP/IP protocol stack 43, the storage driver 44, a buffer cache 45, a file system 46, the direct transmission HW driver (transmission driver) 47, and a system call unit 48. The application program 51 is a program to operate on the OS 41, and in the embodiment, the program is a caching server program.

The network driver 42 of the OS 41 is a device driver to transmit and receive data to the network 301 through the network input/output unit 21 included in the direct transmission HW unit 11.

The TCP/IP protocol stack 43 is a processor to implement the transmitting and receiving of data in accordance with the TCP/IP protocol, and has a function to share processes with the TCP process offloading unit 22. As described above, the header process is performed by the TCP process offloading unit 22, which is hardware, and other processes relevant to the TCP session control are performed by the TCP/IP protocol stack 43, which is a software part.

The storage driver 44 is a device driver to implement the access to the storage 12 connected by the SATA, through the SATA input/output unit 24 included in the direct transmission HW unit 11.

The buffer cache 45 caches some data in the storage 12 into the main memory 32, replaces reading and writing to the storage with a cache access to main memory 32, and thereby reduces the number of times of access to the storage 12. This achieves an increase in data access speed.

The file system 46 is a processor to logically format the storage area of the storage 12 and to implement the data management by files. Examples of such logical format scheme include the FAT file system, the exFAT file system, the UNIX file system, the Berkley Fast file system and the ext file system. In the embodiment, particularly, any scheme is allowable.

The direct transmission HW driver 47 is a device driver to take out the corresponding data (here, response data) from a series of sectors that constitute a file in the SATA storage 12, and to perform an instruction to transmit the response data directly by TCP/IP (that is, without the process by the TCP/IP protocol stack 43). In the present application, the caching server program unit 51 performs a data transmission instruction with a “sendfile( )” system call of the system call unit 48, and on this occasion, the direct transmission HW driver 47 instructs the direct-storage-access processor 23 and the TCP process offloading unit 22 to start the processes. The direct-storage-access processor 23 extracts a sector sequence with respect to a file designated from the direct transmission HW driver 47, takes out the corresponding data (response data) from the extracted sector column, and passes the response data to the TCP process offloading unit 22. The TCP process offloading unit 22 adds an IP header and a TCP header to the response data to make packets, and transmits the packets to the network 301.

The system call unit 48 is a processor to provide a program interface with the caching server program unit (application program) 51. The implementation method varies depending on the OS, and in many cases, software exceptions provided by the CPU 31 are used. Also, the function to be provided varies depending on the OS, and in the embodiment, a “recv( )” system call for receiving data from a network, a “write( )” system call for writing data to a file (a storage), and a “sendfile( )” system call for transmitting file data to the network are shown in the figure.

The caching server program unit 51 includes a cache protocol processor 52, a data-storing instructor 53, a direct transmission instructor 54, and a data placement managing unit 55.

The cache protocol processor 52 is a processor to receive a cache protocol message that is sent from the client 201 through the network 301, and to interpret the content of the cache protocol message. As the cache protocol, which is not limited thereto, the memcached is assumed in the embodiment. As the type of basic request messages, there are a “GET” request message for requesting transmission (acquisition) of data, and a “SET” request message for requesting storing (saving) of data. Other types of request messages may also be implemented. By receiving the “recv( )” system call from the system call unit 48, the cache protocol processor 52 receives the request message from the OS 41.

When the cache protocol processor 52 receives a “SET” request message, the data-storing instructor 53, by an instruction of the data placement managing unit 55, calls the “write( )” system call for performing a process to write a response message (response data) containing data included in the “SET” request message, to a file.

When the cache protocol processor 52 receives a “GET” request message, the direct transmission instructor 54, by an instruction of the data placement managing unit 55, calls the “sendfile( )” system call for performing a process to read data (response data) in a file and transmit the data to the network 301.

The data placement managing unit 55 is a processor to manage use areas and unused areas in the storage 12, and to manage what data is in what location in which file. The data placement managing unit 55 uses data-holding structures each of which describes a key and where data corresponding to the key is held in which file, and thereby manages data for each key. The key is generally called an identifier. The “SET” request and the “GET” request contain a designated key, and the “SET” request further contains data that is an object to be saved. The data placement managing unit 55 has a hash table of keys (a data-holding management table), and provides a scheme by which a targeted data-holding structure can be quickly retrieved from a key.

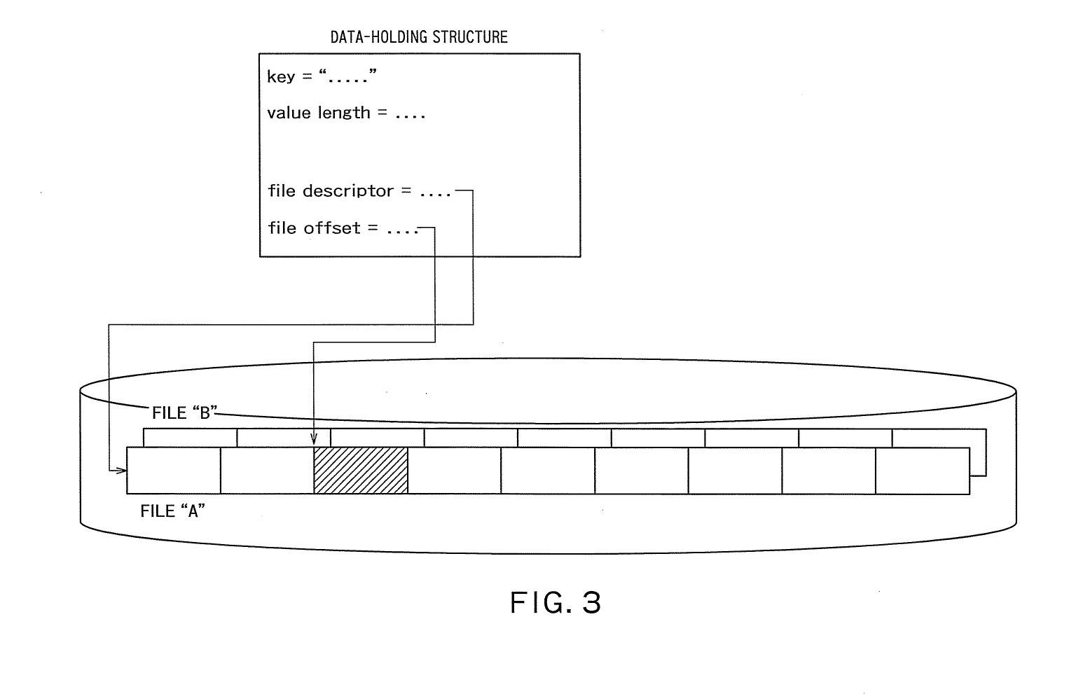

FIG. 3 shows an example of a data-holding structure. The data-holding structure has a “key,” a “value length,” a “file descriptor” and a “file offset.” It is allowable to have other items, for example, an expiration date.

The “key” is a character string that is a retrieval key of data or byte sequence.

The “value length” is a byte length of data for which a saving is requested from the client, corresponding to the “key.”

The “file descriptor” is a descriptor for identifying a file in which stored data is written. The “file descriptor” is an identifier that is used for a file access in a general OS. For example, an “open( )” system call, which converts a file name into a descriptor, is well known. As long as the data is information for identifying a file in which stored data is written, another format is allowable.

The “file offset” is a storage location in a file where the data (the response data containing data for which saving is requested from the client) corresponding to the “key” is stored. The “file offset” indicates a byte location from the top of the file. The figure shows that the corresponding response data is stored at the shaded location in a file “A.” One file holds many pieces of data, and the respective pieces of data are separated by the vertical lines. The embodiment assumes that these respective pieces of data have a format of the response message in the cache protocol.

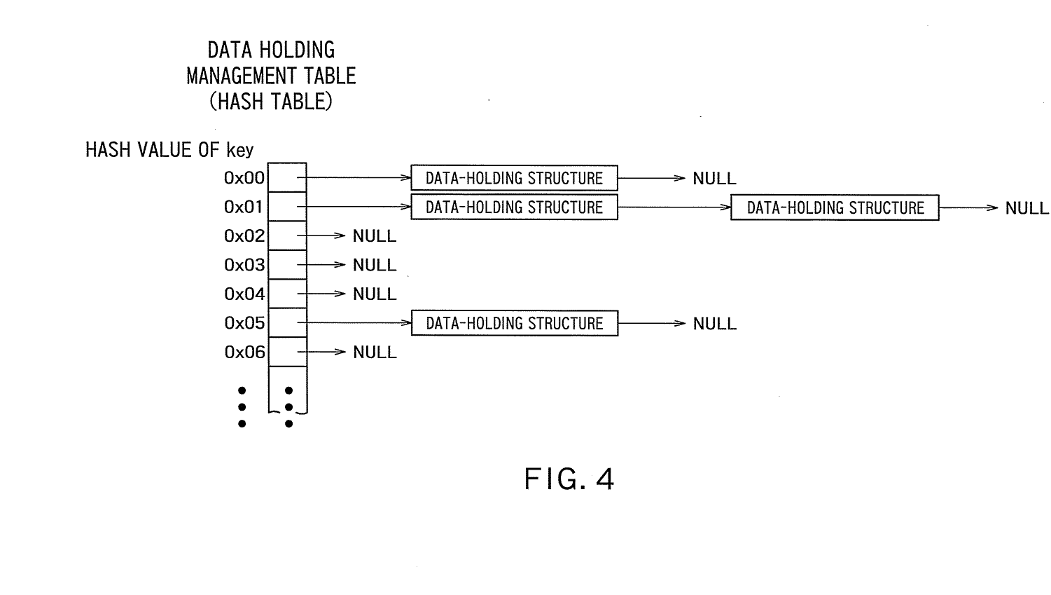

FIG. 4 shows a data-holding management table (a hash table) for quickly retrieving a targeted data-holding structure from a key.

The data-holding management table is a table with which the hash value of the “key” (character string or byte sequence) is calculated and that has the calculated result as an index. Here, there is a possibility that the same hash value is obtained from a plurality of the “keys”. This table has a plurality of entries, and each entry contains a hash value (an index) and a list of data-holding structures for “keys” having the hash value. Thereby, the retrieval of a data-holding structure having a targeted “key” can be implemented by calculating the hash value of the “key,” and then by, from a list of data-holding structures in an entry whose index is the calculated hash value, retrieving a data-holding structure with the matching “key” (character string or byte sequence) value. Concretely, in the example of the figure, in order from the leftmost data-holding structure in a list, check of a data-holding structure is performed with a rightward shift, until a data-holding structure with the matching “key” value is found. The “NULL” indicates the termination of a list, and, if the retrieval reaches the “NULL” without identifying the data-holding structure, the judgment that the data having the targeted “key” are not present is made.

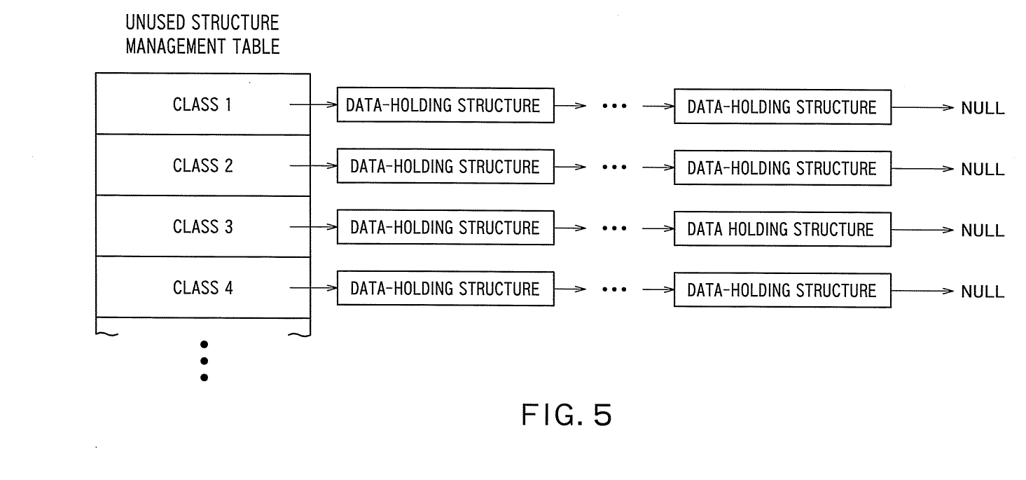

FIG. 5 shows an unused structure management table of data-holding structures. The unused structure management table is managed by the data placement managing unit 55.

The unused structure management table manages unused data-holding structures as a list. The “class” is a classification by the size of a storage area that is allocated for a data-holding structure. It can be determined by design, for example, that 128 bytes or less is “class 1,” over 128 bytes to 256 bytes or less is “class 2,” and over 256 bytes to 1,024 bytes or less is “class 3.” In the case where the response message (response data) generated from the data for which saving is requested by the “SET” request message has a size of 128 bytes or less, a data-holding structure to be used is specified from the list of the data-holding structures classified into the “class 1,” and the data is stored from the top of the location shown by the specified data-holding structure. The used data-holding structure is deleted from the unused structure management table, and is moved to the data-holding management table shown in FIG. 4. That is, after the hash value of the “key” is obtained, it is added to the end (or an arbitrary position) of the list corresponding to the obtained hash value.

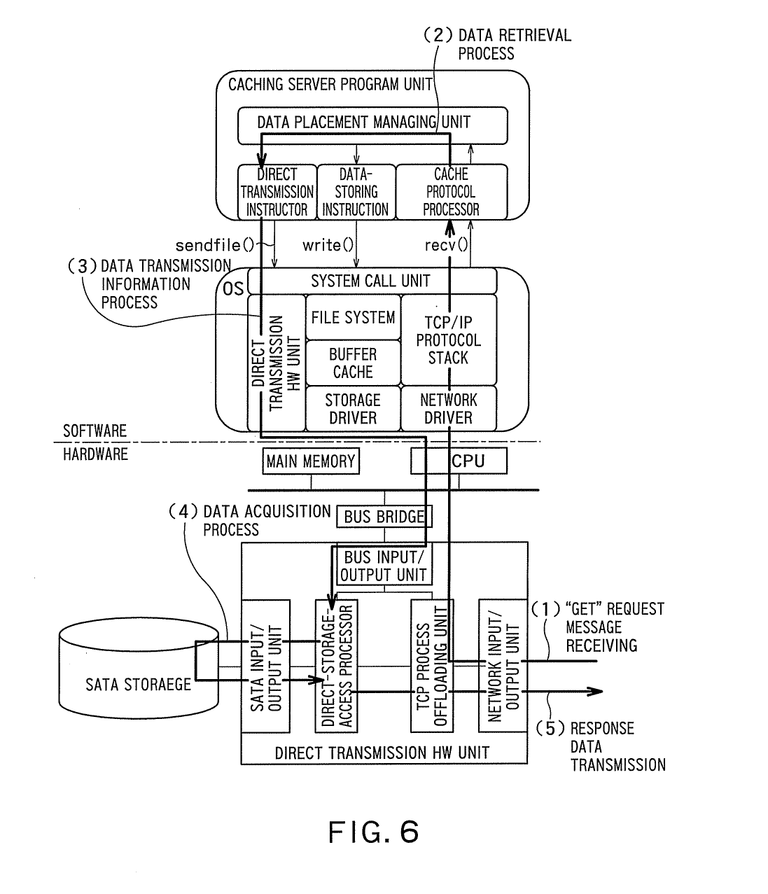

FIG. 6 shows a process sequence when receiving the “GET” request message from the client 201. The flow of the process is shown by the thick lines with arrows. The processors of the blocks through which the thick lines pass perform the processes.

First, the “GET” request message is received ((1)). The cache protocol processor 52 receives the “GET” request message, through the network input/output unit 21, the TCP process offloading unit 22, the network driver 42, the TCP/IP protocol stack 43, and the system call unit 48 (“recv( )” system call).

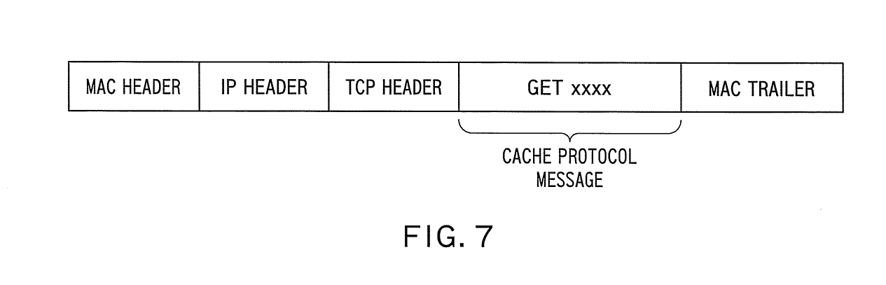

FIG. 7 shows a configuration of the “GET” request message. The MAC header/MAC trailer is processed by the network input/output unit 21, and the IP header and the TCP header are processed by the TCP process offloading unit 22 and the TCP/IP protocol stack 43. These processes may be performed similarly to general communication processes. The cache protocol processor 52 performs the process of the cache protocol message. Here, the cache protocol processor 52 interprets the “GET” request message as the cache protocol message, and understands that the acquisition of the value data whose key is “xxxx” is being requested.

Next, a data retrieval process ((2)), a data transmission instruction process ((3)), a data acquisition process ((4)) and a response data transmission ((5)) are continuously performed.

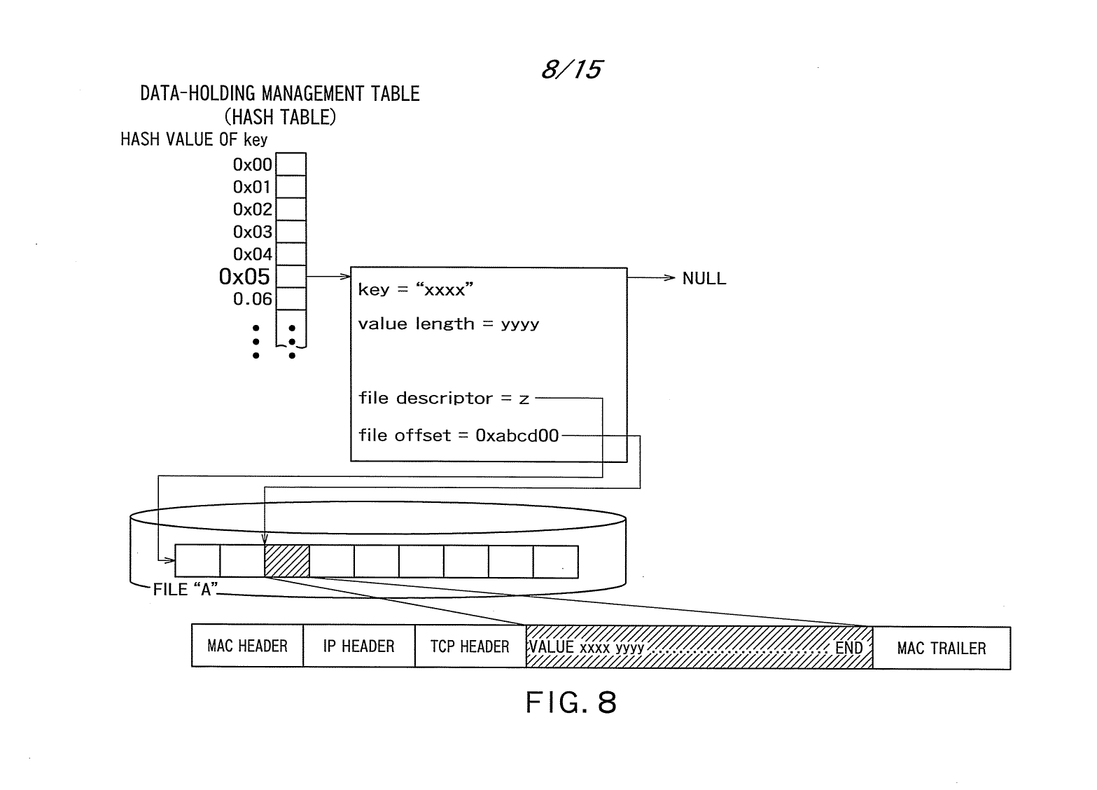

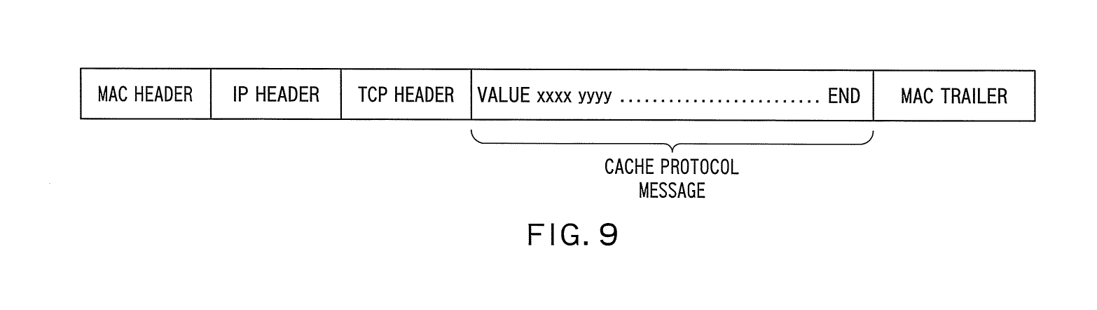

This continuous flow will be concretely described using FIG. 8 and FIG. 9.

As shown in FIG. 8, first, the data placement managing unit 55 calculates the hash value of “xxxx,” which is the key contained in the “GET” request. It is supposed that “0×05” is obtained as the hash value.

In the entry of 0×05, the “key” value of the data-holding structure positioned at the top is checked, and since it is confirmed that the “key” value is “xxxx,” the retrieval is completed ((2)).

The “file descriptor” and “file offset” contained in the data-hold structure indicate the location of the targeted data. The direct transmission instructor 54 sets these “file descriptor” and “file offset” as arguments and calls the “sendfile( )” system call, and thereby instructs data transmission to the direct transmission HW driver 47((3)).

By controlling the direct-storage-access processor 23, while reading the data (response data) at an offset position (“0×abcd00”) in the file (here, “z” (=“file descriptor”) designates the file “A”) designated by the “sendfile( )” from the SATA storage 12, and the direct transmission HW driver 47 passes the data to the TCP process offloading unit 22 ((4)). The TCP process offloading unit 22 adds a header to the passed data to configure packets, and transmits the packets from the network ((5)). Thereby, transmission of the response data is completed.

As shown in FIG. 8, the data (response data) held in a file have a format of the response message. Therefore, simply by adding the TCP header, the IP header and the MAC header/MAC trailer, it is possible to perform transmission of the response message. That is, after receiving the “GET” request message, it is not necessary to compose the response message by a software process in the cache protocol. Therefore, a fast response is possible. Furthermore, since the response message is stored in the SATA storage 12 and is directly read from the SATA storage 12 to be sent, the size of the main memory 32 can be reduced.

FIG. 9 shows an example of the format of the response message (here, it is the same as one shown in the lower side of FIG. 8). For example, the cache protocol message is constituted by “VALUE” showing that it is response data, “xxxx” as a key, “yyyy” as a value length, “. . . ” as a value (data substance), and “END” as the end of a message. Each “x” and “y” of “xxxx” and “yyyy” represent numerical values. In some cases, the expiration date information of data, a check code, a flag showing whether it is compressed data, and the like are added to the response data. An example of the response data with a check code will be described later.

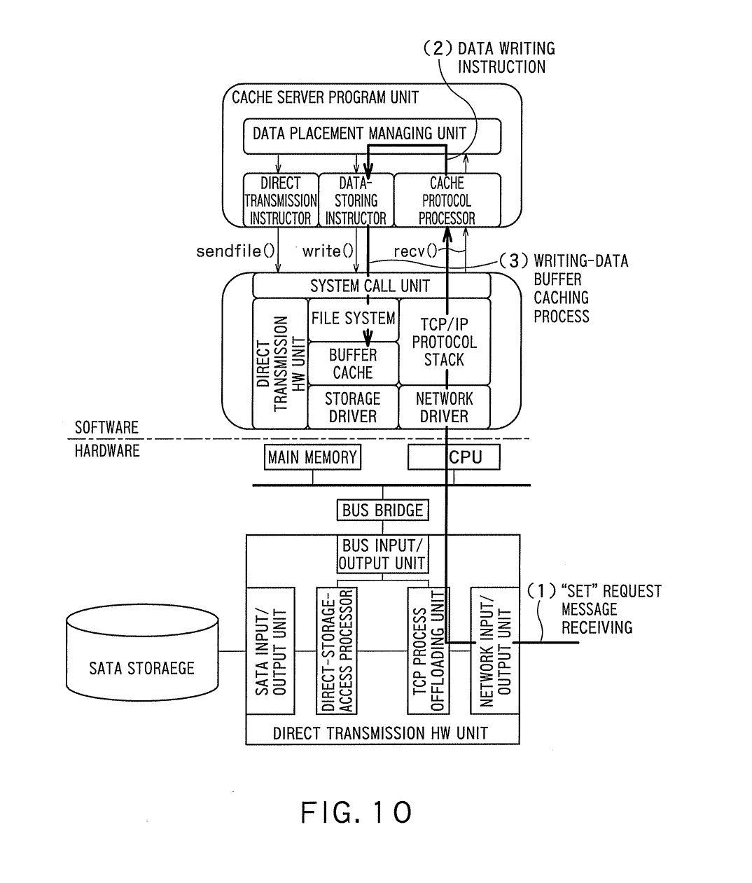

FIG. 10 shows a process sequence (a writing sequence) when receiving the “SET” request message.

The cache protocol processor 52 receives the “SET” request message, through the network input/output unit 21, the TCP process offloading unit 22, the network driver 42, the TCP/IP protocol stack 43, and the system call unit 48 (“recv( )” system call) ((1)).

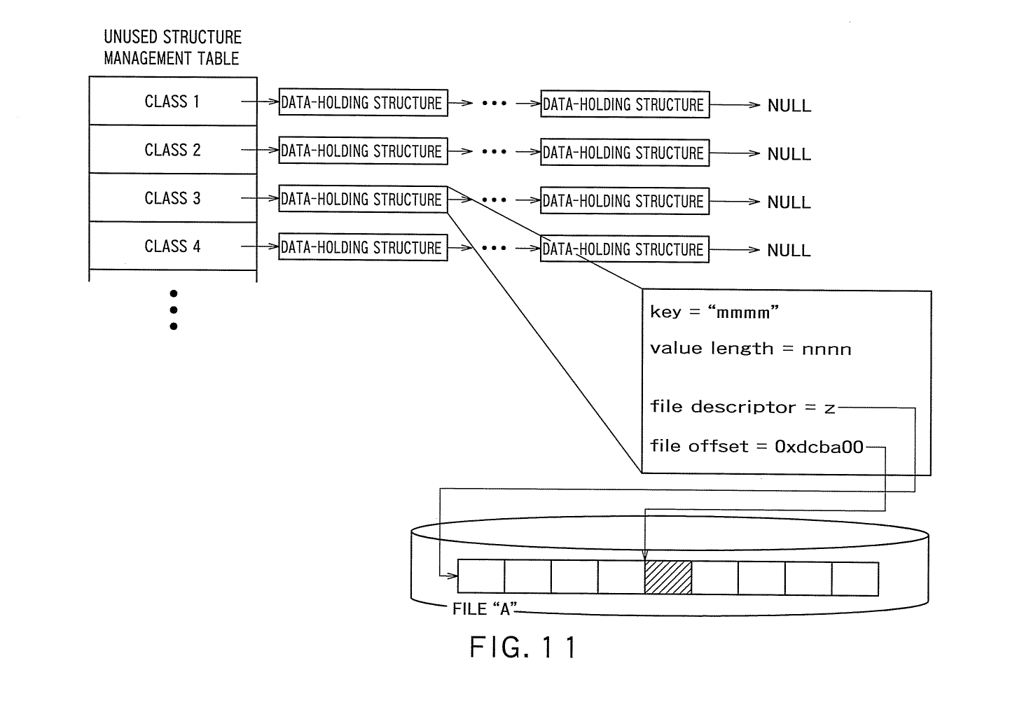

It is supposed that the “SET” request message is a message whose key is “mmmm” (each “m” represents a numerical value) and that instructs holding of data with a length of “nnnn” (each “n” represents a numerical value), as shown in FIG. 11.

First, the data placement managing unit 55 checks the value of “nnnn” and specifies the header length of the response data (response message) that is generated from the data with the length of “nnnn.” It is supposed that the total value of the length of “nnnn” and the header length is the length of the “class 3.”Here, as the header length of the response data, the length of a prescribed longest format (for example, the key is 250 bytes and other numerical values are 16 bytes.) may be used. Alternatively, it is allowable to temporarily make a header of the response data when determining the class, and to use the length of the header.

One unused data-holding structure is taken out from the list of the “class 3” entry in the unused structure management table. In this data-holding structure, a storage area with a size of the “class 3” is allocated at an offset “0×dcba00” in the file “A” (the “file descriptor” is “z.”).

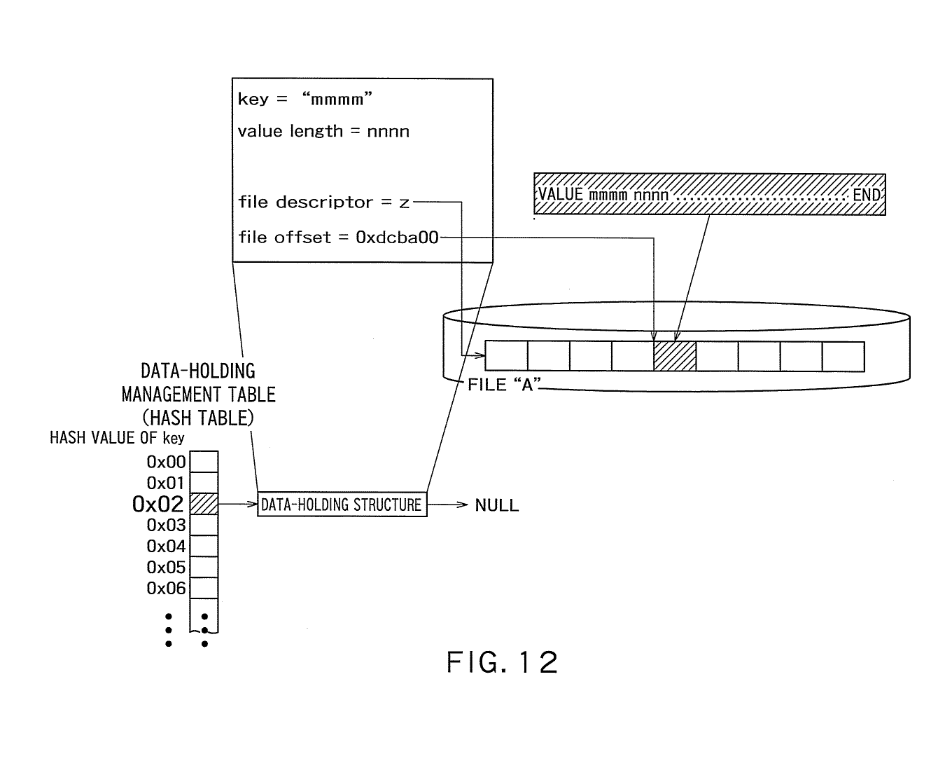

As shown in FIG. 12, the data placement managing unit 55 makes a response message (the shaded part in the right side of the figure) containing “. . . ,” which is the data part contained in the received “SET” request message, and performs an instruction to write the response data to the storage area at the offset “0×dcba00” in the file “A,” through the data-storing instructor 53. Furthermore, the hash value of the key “mmmm” is calculated, and the data-holding structure taken out from the above unused structure management table is added to the list of the entry having the hash value as an index in the hash table. In the example shown in the figure, an example of the case of obtaining “0×02” as the hash value is shown.

Here, in the writing to the file, first, the buffer cache 45 performs caching in the main memory 32 ((3) of FIG. 10). In this case, the buffer cache 45 holds the writing data (response data) in the main memory 32, as a cache. The data written in the main memory 32 are flushed (written back) to the storage 12 in a delayed manner, in accordance with a process of the OS 41. Here, the response data may be directly written to the storage 12, without being cached in the main memory 32.

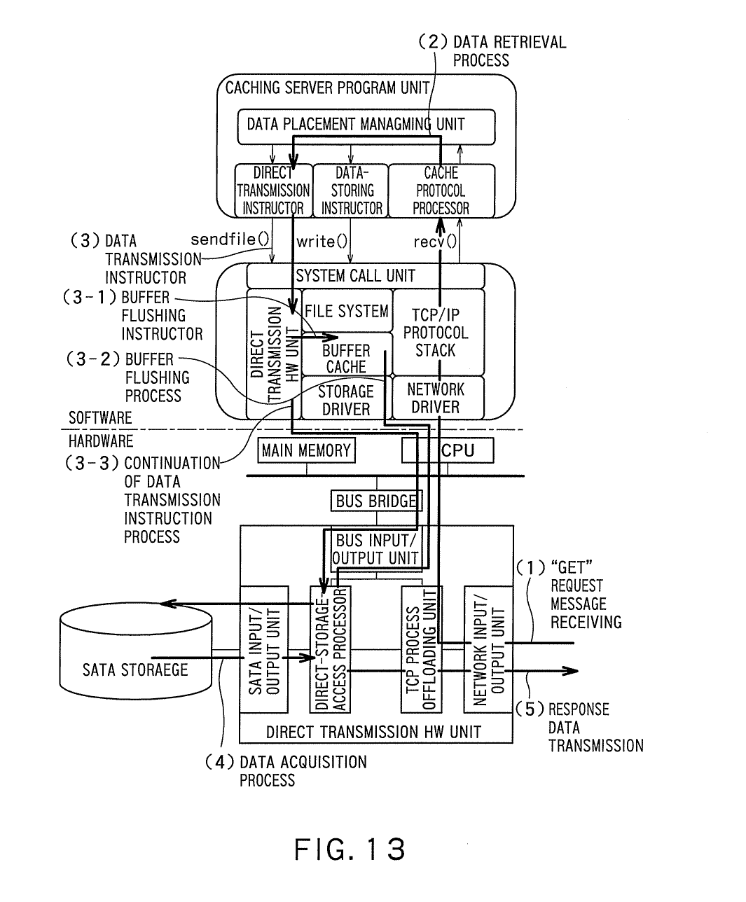

FIG. 13 shows a sequence when a subsequent “GET” request message arrives before the response data in the main memory 32 is flushed.

A sequence when the response data held by the buffer cache 45 contains the data for which acquisition is requested by the subsequent “GET” request message, will be shown. Until the data transmission instruction process, the processes previously described using FIG. 6 are performed ((1), (2), (3)). In the middle of the data transmission instruction process, the direct transmission HW driver 47 performs a flushing instruction for the response data held by the buffer cache 45 ((3-1)). For the purpose of avoiding unnecessary flushing, it is preferable to perform the flushing instruction for only the transmission-targeted data at the offset place in the file. However, it is allowable to perform the flushing instruction for all the data held by the buffer cache 45. Here, only the response data containing the data for which the “GET” request has been performed are buffer-cached, and the response data are flushed back to the storage 12 ((3-2)). The direct transmission HW driver 47 instructs the buffer cache 45 to perform the flushing, and the buffer cache 45 operates the direct-storage-access processor 23 through the storage driver 44 and performs the data writing (flushing back) to the SATA storage 12. Thereafter, the direct transmission HW driver 47 performs the continuation of the data transmission instruction process ((3-3)). Subsequently, the data acquisition process ((4)) and the response data transmission process ((5)) are performed.

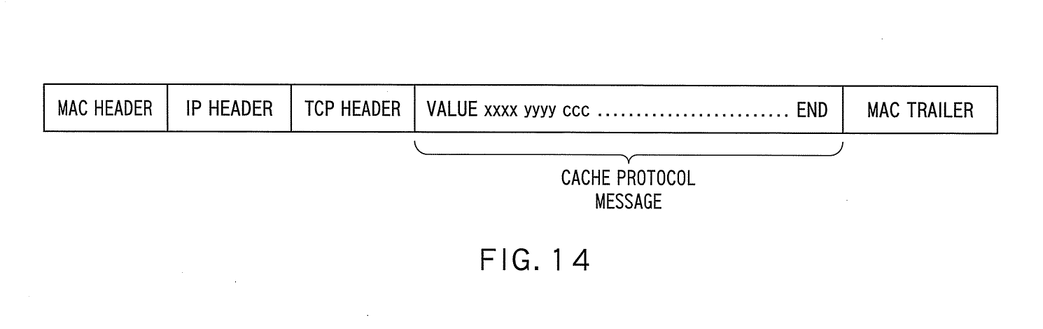

FIG. 14 shows an example of the above-described response data with a check code, as another example of the cache protocol message. In the figure, “ccc” is a check code, which is, for example, a monotonically-increasing sequence number. In addition to the value “. . . ” of the message in FIG. 9, a check code is contained. The addition of the check code is performed by the data placement managing unit 55, at the time of value registration (at the time of update). When receiving a “GETS” request message, the check code is made contained in the response data of the “GETS” request message and sent to the client. As for “GETS” of the “GETS” request message, the character appearance of “GET” of the “GET” request message is merely changed into “GETS.” Here, the check code is utilized for the following purpose.

It is supposed that a certain client A performs a “GETS” request, and receives response data with a check code. Next, when the client A attempts to perform update of the value by designating the check code, in some cases, the check code designated by the client does not match with one that, in the server, is managed by a check code added to the key. That is, another client B has already updated the value for the key after the client A receives the “GETS” response and before the client A updates the value by designating the check code. In such cases, the value update with the check code designation by the client A is rejected. In some cases, the check code is called a “casID (Check and Set ID).”

In some cases, the caching server 101 needs to deal with both of the two types of response data shown in FIG. 9 and FIG. 14. In such cases, for example, by using the “GETS” request for requesting the response data with the check code shown in FIG. 14 in addition to the “GET” request for requesting the response data shown in FIG. 9, the response data corresponding to the multiple requests are respectively made. That is, the data with “ccc” added are generated from the data contained in the “SET” request, and the multiple types of response data are made. One type of the response data includes the key and data (the data contained in the “SET” request), and another type of the response data includes the same key and data (the data with “ccc” added). The caching server 101 discriminates between the response data to be responded for the “GET” request and the response data to be respond for the “GETS” request, and thus discriminates the response data to be returned, in response to the request from the client.

The discrimination of the type of the response data by the presence or absence of the check code is just one example, and the type of the response data is not limited to this. For example, a case where the protocol supports both text messages (in which “GET” and the like are readable for human) and binary messages (whose character appearances are numerical values after encoded), and a case where the contents of the response data for same key and value are different such as, for example, whether the data are compressed, are allowable.

For example, a text response is performed for a request message of ASCII strings, and a binary response is performed for a request message of binary data. Thus, a value is not only stored corresponding to a key, like a typical key-value database, but also, if data (character appearance) to be responded differ for each request, response data containing a different value (data) is stored for each correspondence of the request and the key.

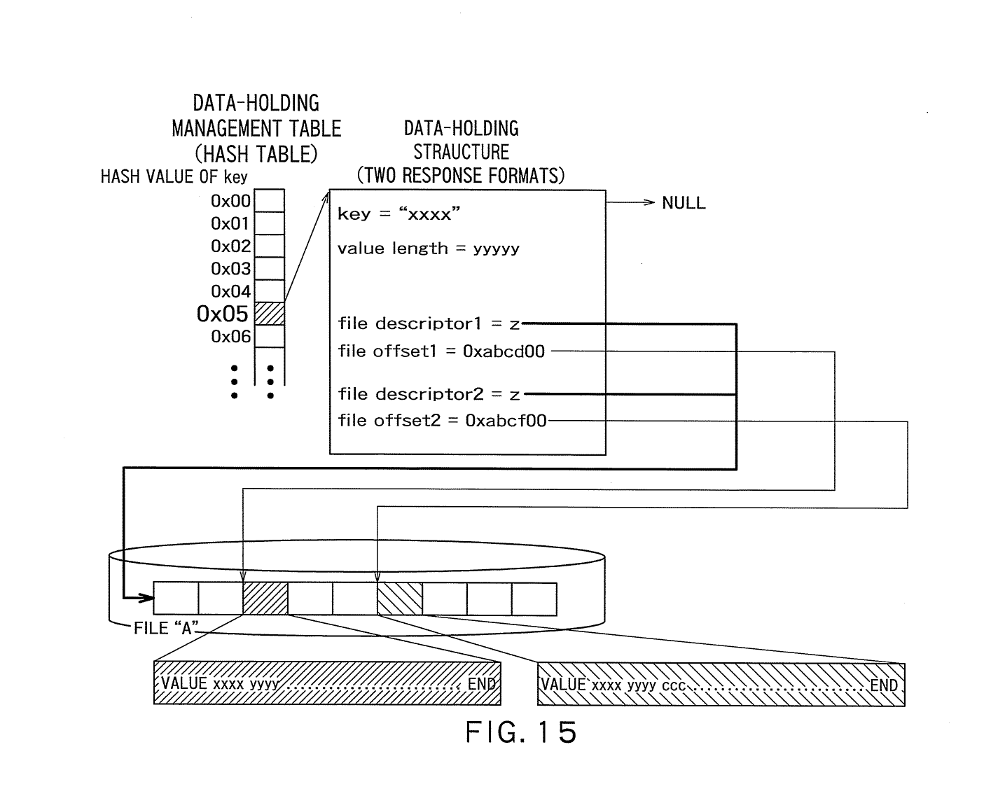

FIG. 15 shows an extended structure of a data-holding structure for supporting multiple response data formats in that way. In this example, the data-holding structure supports two types of response data. Pieces of response data themselves corresponding to the respective types are stored in a file (in the example, the file “A”), and the respective storage locations (two locations) are put in a data-holding structure. It is allowable to manage these storage locations as a table, an array or a list structure, and support the increase in the number of response data. It is allowable to understand that the “descriptor 1” corresponds to the response data without “ccc” and the “descriptor 2” corresponds to the response data with “ccc,” or it is allowable to understand that the first (upper) description corresponds to the response data without “ccc” and the second description corresponds to the response data with “ccc.” Alternatively, the information for discriminating the type of response data may be added to the data-holding structure. In any case, the data-holding structure manages the correspondence of the key, the two types of response data and the two storage locations.

Here, in the example of FIG. 15, the respective pieces of response data are present in the same file, but the respective pieces of response data may be present in different files. That is, the values of the “file descriptors” may be different corresponding to the response data.

In the embodiment, the block configuration in the upper side of FIG. 2 has been described as the functional block configuration of the software executed by the CPU of the caching server 101. However, it does not necessarily have to be implemented in the software executed by the CPU, and a part or whole of the configuration may be implemented in hardware. In the embodiment, the example in which the caching server 101 receives the data saving request message, and on this occasion, generates the response message to save it in the storage, has been described. However, the response message may be previously saved in the storage, by the caching server 101 or another apparatus. In this case, instead of performing a process to generate the response message when receiving the data saving request message, the caching server 101 may perform a process to transmit the response message previously stored in the storage, when receiving the data acquisition request message.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A data transferring apparatus to communicate with a communicating apparatus through a network in accordance with a predetermined protocol, comprising:
a writing controller to perform control of writing a first response message containing first data to a storage; and
a transmission controller to perform control of reading the first response message from the storage and transmitting the first response message to the communicating apparatus upon receiving a data acquisition request message for the first data from the communicating apparatus.

2. The data transferring apparatus according to claim 1, further comprising,
a data managing unit to generate the first response message containing the first data, upon receiving a data saving request message containing the first data from the communicating apparatus.

3. The data transferring apparatus according to claim 1,
wherein the first response message is a response message in a format of the predetermined protocol.

4. The data transferring apparatus according to claim 2,
wherein the data saving request message contains a first identifier that is an identifier of the first data,
the data managing unit generates the first response message containing the first data and the first identifier,
the data managing unit manages correspondence of the first identifier and a first storage location that is a storage location of the first response message in the storage,
the writing controller performs control of writing the first response message to the first storage location,
the data managing unit identifies the first storage location at which the first response message is stored, based on the first identifier, upon receiving a data acquisition request message in which the first identifier is designated from the communicating apparatus, and
the transmission controller performs control of reading the first response message from the first storage location identified in the storage and transmitting the first response message to the communicating apparatus.

5. The data transferring apparatus according to claim 4,
wherein the data managing unit manages a used area and an unused area in the storage, and reserves the first storage location based on a size of the first response message.

6. The data transferring apparatus according to claim 5,
wherein the data managing unit generates a second to an N-th (N is an integer of two or more) data based on the first data, makes a first to an N-th response message containing the first identifier and the first to the N-th data respectively, determines a first to an N-th storage location that are respective storage locations of the first to the N-th response messages, based on respective sizes of the first to N-th response messages, and manages correspondence of the first identifier, the first to the N-th response messages and the first to the N-th storage locations,
the writing controller writes the first to the N-th response messages to the first to the N-th storage locations, respectively,
the data managing unit identifies a storage location at which an X-th (X is an integer of 1 or more to N or less) response message is stored, upon receiving an X-th data acquisition request message in which the first identifier is designated, and
the transmission controller reads the X-th response message from the storage location identified by the data managing unit, and transmits the X-th response message to the communicating apparatus.

7. The data transferring apparatus according to claim 1, comprising,
a buffer cache to temporarily buffer the first response message in a main memory before the first response message is written in the storage,
wherein, when receiving the data acquisition request message while the first response message is being buffered in the main memory, the writing controller performs control of reading the first response message that is being buffered from the main memory and writing the first response message to the storage, and makes the transmission controller wait to operate until the writing to the storage is completed.

8. The data transferring apparatus according to claim 4,
wherein the data managing unit determines the storage location of the first response message by a file name and an offset from a top position of a file.

9. The data transferring apparatus according to claim 1, comprising,
a hardware-based transmission device including an access processor to access the storage, and a communication processor to communicate with the communicating apparatus,
wherein the transmission controller reads the first response message from the storage by controlling the access processor, and
the communication processor transmits the first response message read from the storage, to the communicating apparatus.

10. The data transferring apparatus according to claim 9,
wherein the communication processor communicates with the communicating apparatus,
the data managing unit receives the data saving request message from the communicating apparatus through the communication processor, and
the writing controller writes the first response message to the storage by controlling the access processor.

11. A data transferring system to communicate with a communicating apparatus through a network in accordance with a predetermined protocol, comprising:
a storage storing a first response message containing first data therein; and
a transmission controller to perform control of reading the first response message from the storage and transmitting the first response message to the communicating apparatus, upon receiving a data acquisition request message for the first data from the communicating apparatus.

12. A non-transitory computer readable medium having instructions stored therein which causes, which executed by a processor in a data transferring apparatus to communicate with a communicating apparatus through a network in accordance with a predetermined protocol, to perform processing of steps comprising:
instructing a writing controller to write a first response message containing first data to a storage; and
instructing a transmission controller to perform control of reading the first response message from the storage and transmitting the first response message to the communicating apparatus, upon receiving a data acquisition request message for the first data from the first communicating apparatus.
